(19) United States
(12) Patent Application Publication
(10) Pub. No.: US 2009/0273860 A1
(43) Pub. Date: Nov. 5, 2009

(54) CONTACT HEAD SLIDER AND STORAGE APPARATUS

(75) Inventor: Junichi Ichihara, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/353,043

(22) Filed: Jan. 13, 2009

(30) Foreign Application Priority Data
May 1, 2008 (JP) 2008-119814

(51) Int. Cl. G11B 17/32

(52) U.S. Cl. 360/235.4; G9B/17.061

(57) ABSTRACT

A contact surface of a contact head slider is received on a film of a lubricant on a storage medium. The rotation of the storage medium allows the contact surface to slide on the surface of the storage medium. The lubricant adheres to the contact surface. The groove is formed on the rear rail between the contact surface and an air bearing surface. The lubricant on the contact surface is forced to flow into the groove based on so-called meniscus effect. Since the air bearing surface extends at a level lower than that of the contact surface, the air bearing surface is prevented from adhesion of the lubricant. A positive pressure is thus reliably generated at the air bearing surface. The contact head slider is allowed to slide on the surface of the storage medium with a high stability.

### CROSS-REFERENCE TO RELATED APPLICATION

This application is based upon and claims the benefit of priority from the prior Japanese Patent Application No. 2008-119814 filed on May 1, 2008, the entire contents of which are incorporated herein by reference.

### BACKGROUND OF THE INVENTION

1. Field of the Invention

The present invention relates to a head slider incorporated in a storage apparatus such as a hard disk drive, HDD.

2. Description of the Prior Art

A contact head slider is expected to enhance the recording density in a hard disk drive, HDD, for example. The contact head slider is designed to contact with a rotating magnetic recording disk so as to write/read magnetic bit data into/from the magnetic recording disk, for example. The contact head slider includes a rear rail formed at the outflow end of a bottom surface. A contact pad is formed on the top surface of the rear rail. A contact surface is defined on the top surface of the contact pad. The tip end of an electromagnetic transducer is exposed at the outflow end of the contact surface. A so-called air bearing surface is defined on the top surface of the rear rail at a position adjacent to the contact pad. A head suspension applies the urging force to the contact head slider so that the urging force is balanced with the positive pressure acting on the air bearing surface based on airflow generated along the surface of the rotating magnetic recording disk. The balance of the urging force and the positive pressure enables the contact pad sliding on the surface of the magnetic recording disk with a relatively high rigidity.

A lubricant film is formed on the surface of the magnetic recording disk. The lubricant film flows upward into a step formed between the contact surface and the air bearing surface during the sliding movement of the contact pad on the surface of the magnetic recording disk. The contact head slider in this manner suffers from a so-called meniscus effect. The lubricant film spreads over the air bearing surface defined on the top surface of the rear rail. The expected positive pressure cannot thus be generated on the air bearing surface. This results in imbalance between the urging force of the head suspension and the positive pressure. The contact head slider thus loses a stability in the sliding movement. A distance varies between the electromagnetic transducer mounted on the contact head slider and the magnetic recording disk. The recording density cannot be enhanced.

### SUMMARY OF THE INVENTION

It is accordingly an object of the present invention to provide a contact head slider capable of sliding with a high stability.

According to the present invention, there is provided a contact head slider comprising: a slider body having the bottom surface; an insulating non-magnetic film formed on the outflow end surface of the slider body; a rear rail formed on the bottom surface near the outflow end of the slider body, the rear rail extending on the insulating non-magnetic film; a contact surface formed on the rear rail, the contact surface reaching the outflow end of the rear rail; a head element embedded in the insulating non-magnetic film, the head element having the tip end exposed at the contact surface; an air bearing surface formed on the rear rail, the air bearing surface extending along a line parallel to the contact surface at a level lower than the level of the contact surface; and a groove formed on the rear rail at a position between the contact surface and the air bearing surface, the groove extending toward the outflow end of the rear rail.

The contact surface of the contact head slider is received on a film of a lubricant on a storage medium, for example. The rotation of the storage medium allows the contact surface to slide on the surface of the storage medium. The lubricant adheres to the contact surface. The groove is formed on the rear rail at a position between the contact surface and the air bearing surface. The lubricant on the contact surface is forced to flow into the groove based on so-called meniscus effect. Since the air bearing surface extends at a level lower than that of the contact surface, the air bearing surface is prevented from adhesion of the lubricant. A positive pressure or a lift is thus reliably generated at the air bearing surface. The contact head slider is allowed to slide on the surface of the storage medium with a high stability. The contact head slider is preferably incorporated in a storage apparatus.

Additional objects and advantages of the invention will be set forth in part in the description which follows and, in part will be obvious from the description, or may be learned by practice of the present invention. The object and advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the inner structure of a hard disk drive, HDD, as a specific example of a storage apparatus according to the present invention;

FIG. 2 is a perspective view schematically illustrating a contact head slider according to a first embodiment of the present invention;

FIG. 3 is a side view schematically illustrating the inclined attitude of the contact head slider;

FIG. 4 is an enlarged partial sectional view schematically illustrating a contact pad sliding on the surface of a magnetic recording disk; and

FIG. 5 is a perspective view schematically illustrating a contact head slider according to a second embodiment of the present invention.

### DESCRIPTION OF THE PREFERRED EMBODIMENTS

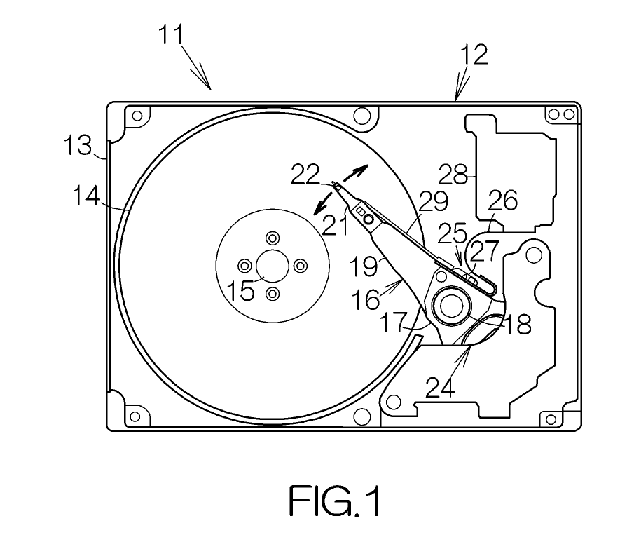

FIG. 1 schematically illustrates the structure of a hard disk drive, HDD, 11 as an example of a storage medium drive or a storage apparatus according to the present invention. The hard disk drive 11 includes an enclosure 12. The enclosure 12 includes a box-shaped base 13 and a cover, not shown. The base 13 defines an inner space in the form of a flat parallelepiped, for example. The base 13 may be made of a metallic material such as aluminum, for example. Molding process may be employed to form the base 13. The cover is coupled to the opening of the base 13. A sealed inner space is defined between the base 13 and the cover. Pressing process may be employed to form the cover out of a plate material, for example.

At least one magnetic recording disk 14 as a storage medium is enclosed in the enclosure 12. The magnetic recording disk or disks 14 are mounted on the driving shaft of a spindle motor 15. The spindle motor 15 drives the magnetic recording disk or disks 14 at a higher revolution speed such as 3,600 rpm, 5,400 rpm, 7,200 rpm, 10,000 rpm, 15,000 rpm, or the like.

A carriage 16 is also enclosed in the enclosure 12. The carriage 16 includes a carriage block 17. The carriage block 17 is supported on a vertical support shaft 18 for relative rotation. Carriage arms 19 are defined in the carriage block 17. The carriage arms 19 extend in the horizontal direction from the vertical support shaft 18. The carriage block 17 may be made of aluminum, for example. Extrusion molding process may be employed to form the carriage block 17, for example. The carriage block 17 may be made of a metallic material such as aluminum, for example. Extrusion process may be employed to make the carriage block 17, for example.

A head suspension 21 is attached to the front or tip end of the individual carriage arm 19. The head suspension 21 extends forward from the carriage arm 19. A so-called gimbal spring, not shown, is attached to the front or tip end of the head suspension 21. A contact head slider 22 is fixed to the surface of the gimbal spring. The gimbal spring accepts a change of attitude of the contact head slider 22 relative to the head suspension 21. A head element or electromagnetic transducer is mounted on the contact head slider 22.

When the magnetic recording disk 14 rotates, the contact head slider 22 is allowed to receive airflow generated along the rotating magnetic recording disk 14. The airflow serves to generate a positive pressure or a lift as well as a negative pressure on the contact head slider 22. The lift is balanced with the urging force from the head suspension 21 and the negative pressure, so that the contact head slider 22 is allowed to keep sliding on the surface of the magnetic recording disk 14 during the rotation of the magnetic recording disk 14 with a relatively high rigidity.

When the carriage 16 swings around the vertical support shaft 18 during the sliding movement of the contact head slider 22, the contact head slider 22 is allowed to move in the radial direction of the magnetic recording disk 14. The electromagnetic transducer on the contact head slider 22 is thus allowed to cross the data zone defined between the innermost and outermost recording tracks. The electromagnetic transducer on the contact head slider 22 is positioned on a target recording track on the magnetic recording disk 14.

A power source such as a voice coil motor, VCM, 24 is coupled to the carriage block 17. The voice coil motor 24 serves to drive the carriage block 17 around the vertical support shaft 18. The rotation of the carriage block 17 allows the carriage arms 19 and the head suspensions 21 to swing.

As is apparent from FIG. 1, a flexible printed circuit board unit 25 is placed on the carriage block 17. The flexible printed circuit board unit 25 includes a head IC (integrated circuit) 27 mounted on a flexible printed wiring board 26. The head IC 27 is designed to supply the read element of the electromagnetic transducer with a sensing current when the magnetic bit data is to be read. The head IC 27 is also designed to supply the write element of the electromagnetic transducer with a writing current when the magnetic bit data is to be written. A small-sized circuit board 28 is placed within the inner space of the enclosure 12. A printed circuit board, not shown, is attached to the backside of the bottom plate of the base 13. The head IC 27 receives the sensing current and the writing current from the small-sized circuit board 28 or the printed circuit board on the bottom plate through the small-sized circuit board 28.

A flexure 29 is utilized to supply the sensing current and the writing current. The flexure 29 is related to the individual contact head slider 22. The flexure 29 may include a metallic thin plate such as a stainless steel plate and layers such as an insulating layer, an electrically-conductive layer and a protection layer overlaid on the metallic thin plate in this sequence. The electrically-conductive layer provides a wiring pattern extending on the metallic thin plate. The electrically-conductive layer may be made of an electrically-conductive material such as copper. The insulating layer and the protection layer may be made of a resin material such as polyimide resin.

The wiring pattern on the flexure 29 is connected to the contact head slider 22 at one end or the front end of the flexure 29. An adhesive may be utilized to bond the flexure 29 on the head suspension 21, for example. The flexure 29 extends backward from the head suspension 21 along the carriage arm 19. The other end or rear end of the flexure 29 is coupled to the flexible printed circuit board unit 25. The wiring pattern on the flexure 29 is connected to a wiring pattern, not shown, formed on the flexible printed circuit board unit 25. Electric connection is in this manner established between the contact head slider 22 and the flexible printed circuit board unit 25.

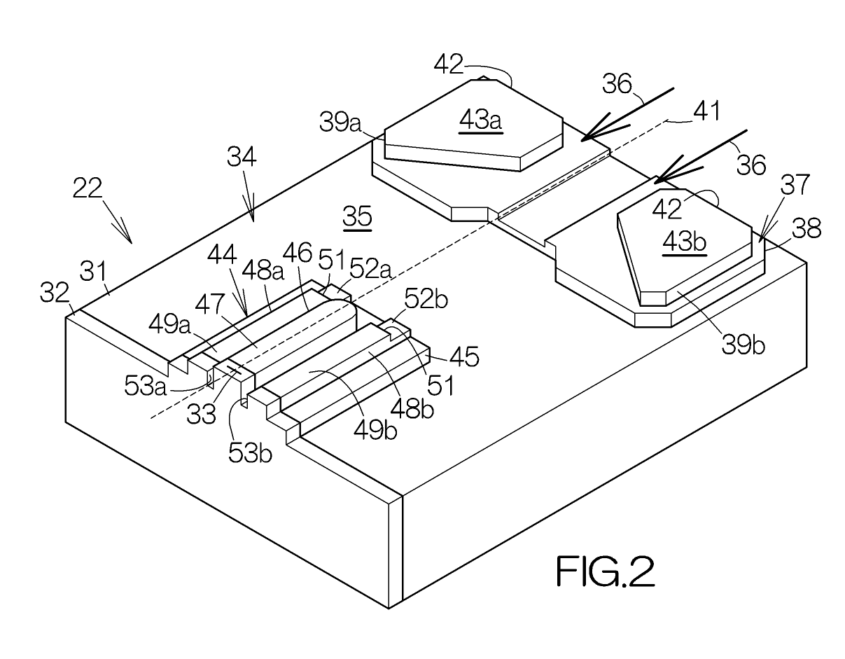

FIG. 2 schematically illustrates the structure of the contact head slider 22 according to a first embodiment of the present invention. The contact head slider 22 includes a slider body 31 in the form of a flat parallelepiped, for example. An insulating non-magnetic film, namely a head protection film 32, is overlaid on the outflow or trailing end surface of the slider body 31. An electromagnetic transducer 33 is incorporated in the head protection film 32. The slider body 31 may be made of a hard material such as Al₂O₃-TiC. The head protection film 32 may be made of a soft material such as Al₂O₃ (alumina). A medium-opposed surface, namely a bottom surface 34, is defined over the slider body 31 so as to face the magnetic recording disk 14 at a distance. A flat base surface 35 as a reference surface is defined on the bottom surface 34. When the magnetic recording disk 14 rotates, airflow 36 flows along the bottom surface 34 from the inflow or front end toward the outflow or rear end of the slider body 31.

A front rail 37 is formed on the bottom surface 34 of the slider body 31. The front rail 37 stands upright from the base surface 35 at a position near the upstream or inflow end of the slider body 31. The front rail 37 includes a rail base 38 having a predetermined thickness formed on the base surface 35. The rail base 38 extends along the inflow end of the base surface 35 in the lateral direction perpendicular to the direction of the airflow 36. A pair of front pads 39a, 39b is formed on the top surface of the rail base 38. The front pads 39a 39b are spaced from each other in the lateral direction of the slider body 31. An interval extends along the longitudinal centerline 41 of the flat base surface 35 between the front pads 39a, 39b. The longitudinal centerline 41 connects the center of the inflow end of the slider body 31 in the lateral direction to the center of the outflow end of the slider body 31 in the lateral direction on the base surface 35. Steps 42 are formed at the inflow ends of the front pads 39a, 39b, respectively. Front air bearing surfaces 43a, 43b are defined on the top surfaces of the front pads 39a, 39b, respectively.

Likewise, a rear rail 44 is formed on the bottom surface 34 of the slider body 31. The rear rail 44 stands upright from the base surface 35 at a position near the downstream or outflow end of the slider body 31. The rear rail 44 is located at the intermediate position in the lateral direction of the slider body 31. The rear rail 44 includes a rail base 45 formed on the base surface 35. The rail base 45 has the same thickness as that of the aforementioned rail base 38. The rail base 45 extends to the outflow end of the base surface 35 along the longitudinal centerline 41. The rail base 45 extends on the head protection film 32. A contact pad 46 is formed on the top surface of the rail base 45. The contact pad 46 extends to reach the outflow end of the rail base 45. The inflow end of the contact pad 46 is located at a position downstream of the inflow end of the rail base 45. The corners of the inflow end of the contact pad 46 are rounded. A contact surface 47 is defined on the top surface of the contact pad 46. The tip end of the electromagnetic transducer 33 is exposed at the contact surface 47.

A pair of rear pads 48a, 48b is formed on the top surface of the rear rail 44 in parallel with the contact pad 46. The rear pads 48a, 48b extend in parallel with the longitudinal centerline 41. The rear pads 48a, 48b extend from the inflow end of the rail base 45 to reach the outflow end of the rail base 45. The thickness of the rear pads 48a, 48b is set smaller than that of the contact pad 46. Rear air bearing surfaces 49a, 49b are defined on the top surfaces of the rear pads 48a, 48b, respectively. The rear air bearing surfaces 49a, 49b extend at a level lower than that of the contact surface 47. Steps 51 are defined at the inflow ends of the rear air bearing surfaces 49a, 49b, respectively. The steps 51 serve to define low level surfaces 52a, 52b on the rear pads 48a, 48b at positions upstream of the rear air bearing surfaces 49a, 49b, respectively. The low level surfaces 52a, 52b extend at a level lower than that of the rear air bearing surfaces 49a, 49b.

A pair of slits or grooves 53a, 53b is formed at positions between the contact surface 47 and the rear air bearing surfaces 49a, 49b, namely between the contact pad 46 and the rear pads 48a, 48b, respectively. The grooves 53a, 53b extend in parallel with the longitudinal centerline 41. Accordingly, the grooves 53a, 53b extend in parallel with each other. The grooves 53a, 53b extend to end at the outflow end of the rail base 45. The grooves 53a, 53b open at the outflow end surface of the head protection film 32. The inward wall surfaces of the grooves 53a, 53b are defined on the side surfaces of the contact pad 46 and the side surfaces of the corresponding rear pads 48a, 48b, respectively. The bottom surfaces of the grooves 53a, 53b are defined on the top surface of the rail base 45.

The aforementioned electromagnetic transducer 33 is embedded in the rear rail 44. The electromagnetic transducer 33 includes a read element and a write element. The read element may include a giant magnetoresistive (GMR) element or a tunnel-junction magnetoresistive (TMR) element designed to discriminate magnetic bit data on the magnetic recording disk 14 by utilizing variation in the electric resistance of a spin valve film or a tunnel-junction film, for example. The write element may include a thin film magnetic head designed to write magnetic bit data into the magnetic recording disk 14 by utilizing a magnetic field induced at a thin film coil pattern. The read gap and the write gap of the electromagnetic transducer 33 are exposed at a position downstream of the contact surface 47.

A protection film, not shown, is formed on the surface of the slider body 31 at the front air bearing surfaces 43a, 43b, the contact surface 47 and the rear air bearing surfaces 49a, 49b, for example. The protection film covers over the read gap and the write gap long the contact surface 47. The protection film may be made of diamond-like-carbon (DLC), for example.

A so-called contact start stop (CSS) mechanism is employed in the hard disk drive 11. When the rotation of the magnetic recording disk 14 is stopped, the contact head slider 22 is received on the surface of the magnetic recording disk 14 at a predetermined stand-by position defined on the surface of the magnetic recording disk 14. When the magnetic recording disk 14 starts to rotate, the airflow 36 is generated along the rotating magnetic recording disk 14. The airflow 36 is received on the bottom surface 34 of the contact head slider 22. The steps 42, 51 serve to generate a larger positive pressure or lift at the front air bearing surfaces 43a, 43b and the rear air bearing surfaces 49a, 49b, respectively. Moreover, a larger negative pressure is induced behind the front rail 37 or at a position downstream of the front rail 37. The balance between the negative pressure and the lift contributes to the stabilization of the attitude of the contact head slider 22.

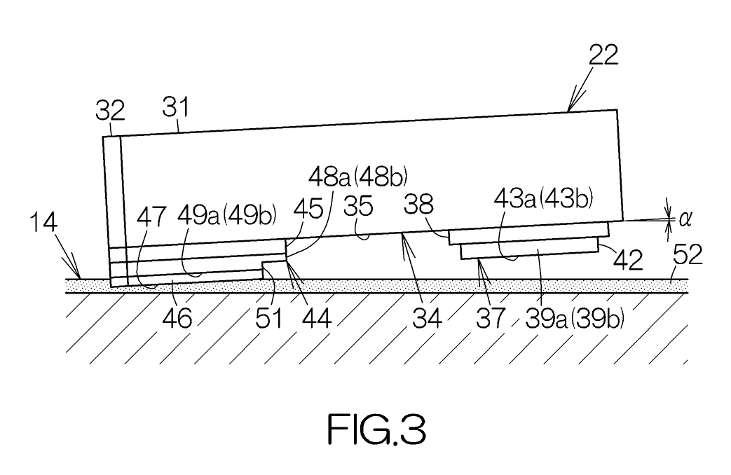

A larger positive pressure or lift is generated at the front air bearing surfaces 43a, 43b as compared with the rear air bearing surfaces 49a, 49b in the contact head slider 22. The slider body 31 can thus be kept at an inclined attitude defined by the pitch angle α as shown in FIG. 3. The term “pitch angle” is used to define the degree of an inclination in the longitudinal direction of the slider body 31 along the direction of the airflow 36. A lift is equally generated at the pair of the front air bearing surfaces 43a, 43b as well as at the pair of the rear air bearing surfaces 49a, 49b. This serves to suppress a change in the roll angle β of the contact head slider 22. Specifically, the slider body 31 is forced to take a predetermined constant roll angle β. The term “roll angle” is used to define the degree of an inclination in the lateral direction of the slider body 31 perpendicular to the direction of the airflow 36.

When the inclined attitude of the contact head slider 22 is established, the contact surface 47 of the contact pad 46 is received on a film of a lubricant 14a formed on the surface of the magnetic recording disk 14. The rotation of the magnetic recording disk 14 allows the contact pad 46 to slide on the surface of the magnetic recording disk 14. The contact surface 47 of the contact pad 46 slides on the lubricant 14a. The lubricant 14a serves to suppress abrasion of the contact pad 46 of the contact head slider 22 to the utmost. The write element of the electromagnetic transducer 33 operates to write magnetic bit data into the magnetic recording disk 14. Likewise, the read element of the electromagnetic transducer 33 operates to read out magnetic bit data on the magnetic recording disk 14.

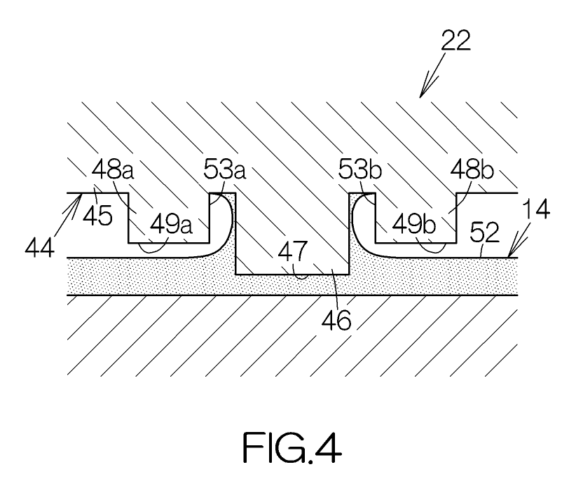

As shown in FIG. 4, the lubricant 14a adheres to the contact pad 46. The lubricant 14a climbs up the side surfaces of the contact pad 46 based on so-called meniscus effect. The lubricant 14a thus reaches the inside of the grooves 53a, 53b. Since the lubricant 14a is in this manner held inside the grooves 53a, 53b, the lubricant 14a is prevented from adhering to the rear air bearing surfaces 49a, 49b on the rear pads 48a, 48b. Moreover, the grooves 53a, 53b open at the outflow end of the rail base 45. A relative movement between the contact pad 46 and the surface of the magnetic recording disk 14 serves to draw the lubricant 14a out of the grooves 53a, 53b at the outflow end of the rail base 45. In this manner, a positive pressure or a lift is reliably generated on the rear air bearing surfaces 49a, 49b. The contact head slider 22 is allowed to slide on the surface of the magnetic recording disk 14 at a high stability.

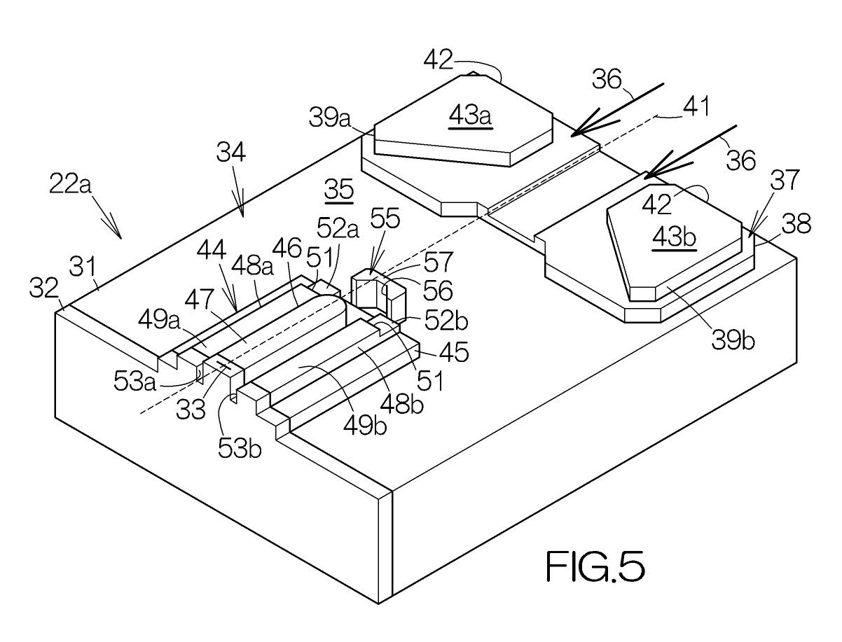

FIG. 5 schematically illustrates the structure of a contact head slider 22a according a second embodiment of the present invention. The contact head slider 22a includes an auxiliary rail 55 formed on the bottom surface 34 between the front rail 37 and the rear rail 44 at a position upstream of the rear rail 44. The auxiliary rail 55 is formed on the longitudinal centerline 41 at a position upstream of the rear rail 44. A recess 56 is formed at the outflow end of the auxiliary rail 55. An auxiliary air bearing surface 57 is defined on the top surface of the auxiliary rail 55. The auxiliary air bearing surface 57 extends within an imaginary plane including the rear air bearing surfaces 49a, 49b. Like reference numerals are attached to the structure or components equivalent to those of the aforementioned contact head slider 22.

The contact head slider 22a allows the auxiliary air bearing surface 57 of the auxiliary rail 55 to receive the airflow 36. A positive pressure or a lift is generated at the auxiliary air bearing surface 57. Simultaneously, a negative pressure is induced inside the recess 56 behind the auxiliary rail 55 or at a position downstream of the auxiliary rail 55. The density of the airflow 36 is thus reduced at a position upstream of the rear rail 44, namely upstream of the contact pad 46. Even when the contact surface 47 of the contact pad 46 receives the airflow 36, the airflow 36 is prevented from compression between the contact surface 47 and the surface of the magnetic recording disk 14. This results in avoidance of generation of a relatively large positive pressure or lift on the contact surface 47. The contact head slider 22a is allowed to slide on the surface of the magnetic recording disk 14 at a high stability.

The turn of the embodiments is not a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A contact head slider comprising:
a slider body having a bottom surface;
an insulating non-magnetic film formed on an outflow end surface of the slider body;
a rear rail formed on the bottom surface near an outflow end of the slider body, the rear rail extending on the insulating non-magnetic film;
a contact surface formed on the rear rail, the contact surface reaching an outflow end of the rear rail;
a head element embedded in the insulating non-magnetic film, the head element having a tip end exposed at the contact surface;
an air bearing surface formed on the rear rail, the air bearing surface extending along a line parallel to the contact surface at a level lower than a level of the contact surface; and
a groove formed on the rear rail at a position between the contact surface and the air bearing surface, the groove extending toward the outflow end of the rear rail.

2. The contact head slider according to claim 1, further comprising:
a front rail formed on the bottom surface at a position upstream of the rear rail;
an auxiliary rail formed on the bottom surface between the rear rail and the front rail at a position upstream of the rear rail; and
an auxiliary air bearing surface formed on a top surface of the auxiliary rail.

3. A storage apparatus comprising:
a recording medium;
a slider body having a bottom surface opposed to the recording medium at a distance;
an insulating non-magnetic film formed on an outflow end surface of the slider body;
a rear rail formed on the bottom surface near an outflow end of the slider body, the rear rail extending on the insulating non-magnetic film;
a contact surface formed on the rear rail, the contact surface reaching an outflow end of the rear rail;
a head element embedded in the insulating non-magnetic film, the head element having a tip end exposed at the contact surface;
an air bearing surface formed on the rear rail, the air bearing surface extending along a line parallel to the contact surface at a level lower than a level of the contact surface; and
a groove formed on the rear rail at a position between the contact surface and the air bearing surface, the groove extending toward the outflow end of the rear rail.

4. The storage apparatus according to claim 3, further comprising:
a front rail formed on the bottom surface at a position upstream of the rear rail;
an auxiliary rail formed on the bottom surface between the rear rail and the front rail at a position upstream of the rear rail; and
an auxiliary air bearing surface formed on a top surface of the auxiliary rail.
